(19) United States
(12) Patent Application Publication
(10) Pub. No.: US 2006/0242888 A1
(43) Pub. Date: Nov. 2, 2006

(54) Attractant compositions and method for attracting biting insects

(75) Inventor: Robert H. Bedoukian, West Redding, CT (US)

Correspondence Address: George W. Rauchfuss, Jr.;Ohlandt, Greeley, Ruggiero & Perle, L.L.P., Tenth Floor, One Landmark Square, Stamford, CT, 06901-2682, US

(73) Assignee: Bedoukian Research, Inc.

(21) Appl. No.: 11/411,308

(22) Filed: Apr. 26, 2006

Related U.S. Application Data
(60) Provisional application No. 60/675,359, filed on Apr. 27, 2005.

(51) Int. Cl. A01M 1/02; A01M 1/06

(52) U.S. Cl. 43/107; 43/139

(57) ABSTRACT

The attractiveness of insects, particularly mosquitoes, to carbon dioxide-containing systems or traps can be significantly and synergistically increased if one of the following components is employed with carbon dioxide, namely:
(a) NO₂ or a material producing NO₂,
(b) NO₂ or a material producing NO₂, and NH₃ or ammonium salts of acids,
(c) NO₂ or a material producing NO₂, and acetone, and
(d) NO₂ or a material producing NO₂, NH₃ or ammonium salts of acids, and acetone.

### RELATED APPLICATION

This application claims priority from U.S. Provisional patent Application No. 60/675,359, filed Apr. 27, 2005

### FIELD OF THE INVENTION

The invention relates to improved compositions or systems for attracting mosquitoes and to methods for attracting biting insects, particularly mosquitoes, employing such compositions and also to systems using such compositions for attracting mosquitoes. The invention also relates to means for reducing the required amount of carbon dioxide needed to effectively attract mosquitoes.

### BACKGROUND TO THE INVENTION

Devices for attracting and destroying biting insects are well known in the art. While the prior art devices have, employed a number of mechanisms and materials to attract insects, such as for example, heat, light, odor emitting substances, pheromones, kairomones and various chemicals, more recently it has been discovered that carbon dioxide alone or with other attractants such as octenol is particularly effective in attracting insects. As examples of devices employing carbon dioxide and octenol are those devices disclosed in U.S. Pat. Nos. 5,205,064 and 6,055,766.

Researchers in the field of entomology have discovered that biting insects such as midges, biting flies and mosquitoes are attracted to blood hosts by the odor of kairomones, which are chemicals given off by the blood host and are attractants to such biting insects. Such kairomones include carbon dioxide exhaled by both avian and mammalian blood host and octenol, an alcohol which is given off by mammalian blood hosts. Mosquitoes and biting flies can detect the odor of carbon dioxide given off by a blood host at distance of approximately 90 meters. Biting insects locate a blood host by tracking the carbon dioxide plume created by a blood host. It has been discovered that a mixture of carbon dioxide and octenol is especially attractive to insects seeking mammalian blood hosts.

In the apparatus and devices heretofore proposed for attracting and/or destroying biting insects, the apparatus and devices rely upon a pressurized canister charged with carbon dioxide or propane/natural gas to generate carbon dioxide, or octenol and, preferably both carbon dioxide and octenol, with or without other semiochemicals or other attractants, to supply the attractant materials to the apparatus or device. However, there are various disadvantages associated with the use of such canisters. Among those disadvantages is the fact that the canister generally is very limited in size and need to be constantly replaced. With the need for replacement the apparatus and device cannot readily be placed in remote locations without the necessity for frequent trips to the location for canister monitoring and replacement. It would therefore be quite beneficial for a reduced amount of carbon dioxide that needs to be provided for effective attraction of biting insects, and to generally improve attraction of existing devices.

### SUMMARY OF THE INVENTION

It has been discovered that the attractiveness of biting insects, particularly mosquitoes, to carbon dioxide-containing systems and traps can be significantly and synergistically increased if one or more of the following components is employed with carbon dioxide, namely:
NO₂ or a material producing NO₂, such as for example, NO₂ producing acids or salts, or NO or N₂O₃ that react with air or disproportionate to give NO₂,
NO₂ or a material producing NO₂, such as for example, NO₂ producing acids or salts, or NO or N₂O₃ that react with air or disproportionate to give NO₂, and NH₃ or ammonium salts of acids,
NO₂ or a material producing NO₂, such as for example, NO₂ producing acids or salts, or NO or N₂O₃ that react with air or disproportionate to give NO₂, and acetone, and
NO₂ or a material producing NO₂, such as for example, NO₂ producing acids or salts, or NO or N₂O₃ that react with air or disproportionate to give NO₂, NH₃ or ammonium salts of acids, and acetone.

The invention is further characterized by a method for attracting biting insects comprising emitting from a trap or system an attractive effective amount of carbon dioxide and a further attractant component selected from
NO₂, or a material producing NO₂, such as for example, NO₂ producing acids or salts, or NO or N₂O₃ that react with air or disproportionate to give NO₂,
NO₂, or a material producing NO₂, such as for example, NO₂ producing acids or salts, or NO or N₂O₃ that react with air or disproportionate to give NO₂, and NH₃ or ammonium salts of acids,
NO₂ or a material producing NO₂, such as for example, NO₂ producing acids or salts, or NO or N₂O₃ that react with air or disproportionate to give NO₂, and acetone, and
NO₂ or a material producing NO₂, such as for example, NO₂ producing acids or salts, or NO or N₂O₃ that react with air or disproportionate to give NO₂, NH₃ or ammonium salts of acids, and acetone.

It has been discovered that even when the amount of carbon dioxide provided by a carbon dioxide-containing system or trap is significantly reduced the attraction of biting insects, particularly mosquitoes, by the system or the trap can remain the same or be improved when the above-mentioned components are employed with the carbon dioxide as attractants in the trap. Thus, one is able to significantly reduce the carbon dioxide requirement of the systems or traps without loss of attractiveness and thus, the needs to replace carbon dioxide cylinders is greatly reduced making the traps much more desirable and useful.

### BRIEF DESCRIPTION OF DRAWING

FIG. 1 is a side elevation view of an insect trapping apparatus according to the invention.

FIG. 2 is a front elevation view of the apparatus illustrated in FIG. 1

FIG. 3 is a section view through line 3—3 of FIG. 2, illustrating details of a suction trap, an electric power generating system, and a CO₂ generating system.

FIG. 3A is an alternative section view through line 3—3 of FIG. 2, illustrating an alternative means of providing a volatile attractant.

FIG. 4 is a section view through line 4—4 of FIG. 1.

FIG. 5 is a section view through line 5—5 of FIG. 2.

FIG. 6 is a circuit diagram of the electrical system for powering fans in the apparatus illustrated in FIG. 1.

FIG. 7 is a graph of the analysis of the results of Examples 2 and 4 using the software program Design-Expert, version 6.

### DETAILED DESCRIPTION OF THE INVENTION AND PREFERRED EMBODIMENTS

In accordance with this invention the attractiveness of biting insects, particularly mosquitoes, to carbon dioxide-containing systems or traps can be significantly and synergistically increased if one or more of the following components is employed along with carbon dioxide in the systems or traps, namely:
NO₂ or a material producing NO₂, such as for example, NO₂ producing acids or salts, or NO or N₂O₃ that react with air or disproportionate to give NO₂,
NO₂ or a material producing NO₂, such as for example, NO₂ producing acids or salts, or NO or N₂O₃ that react with air or disproportionate to give NO₂, and NH₃ or ammonium salts of acids,
NO₂ or a material producing NO₂, such as for example, NO₂ producing acids or salts, or NO or N₂O₃ that react with air or disproportionate to give NO₂, and acetone, and
NO₂ or a material producing NO₂, such as for example, NO₂ producing acids or salts, or NO or N₂O₃ that react with air or disproportionate to give NO₂, NH₃ or ammonium salts of acids, and acetone.

The invention is further characterized by a method for attracting biting insects, particularly mosquitoes, comprising emitting from a trap or system an attractive effective amount of carbon dioxide and a further attractant component selected from
NO₂ or a material producing NO₂, such as for example, NO₂ producing acids or salts, or NO or N₂O₃ that react with air or disproportionate to give NO₂,
NO₂, or a material producing NO₂, such as for example, NO₂ producing acids or salts, or NO or N₂O₃ that react with air or disproportionate to give NO₂, and NH₃ or ammonium salts of acids,
NO₂ or a material producing NO₂, such as for example, NO₂ producing acids or salts, or NO or N₂O₃ that react with air or disproportionate to give NO₂, and acetone, and
NO₂ or a material producing NO₂, such as for example, NO₂ producing acids or salts, or NO or N₂O₃ that react with air or disproportionate to give NO₂, NH₃ or ammonium salts of acids, and acetone.

Even when the amount of carbon dioxide provided by a carbon dioxide-containing system or trap is significantly reduced, the attraction of biting insects, particularly mosquitoes, to the system or trap can remain the same or be improved when the above-mentioned components are employed with the carbon dioxide as attractants in the system or trap. Thus, one is able to significantly reduce the carbon dioxide requirement of the systems or traps without loss of effectiveness in attracting biting insects and thus, the need to replace carbon dioxide cylinders is greatly reduced making the systems or traps much more desirable and useful.

The components to be added to the carbon dioxide-containing systems or traps can be added in any suitable form, preferably as gases in the case of NO₂, NH₃, and acetone, and as either solids or water solutions in the case of ammonium salts of acids. Any suitable effective amount of the components may be employed with the carbon dioxide, the amount being readily determined for any specific component and any insect to be attracted. NO₂ and acetone may be introduced as dilutions in a carbon dioxide pressurized cylinder, or in a gas such as nitrogen. Gas solutions incorporating ammonia either alone or with the other components may be introduced from a pressurized gas such as nitrogen. Any suitable acid salt of ammonia capable of producing ammonia under the conditions of use may be employed, such as for example, ammonium acetate, ammonium butyrate, ammonium lactate, ammonium carbonate, ammonium bicarbonate, ammonium chloride, ammonium bromide, ammonium carbamate and the like, including salts of ammonia and fatty acids. These salts release ammonia slowly upon exposure to air and moisture, but carbon dioxide from the attractant system may be used to acidify the salt or aqueous solution and release ammonia at an accelerated rate. Ammonium bicarbonate does not need carbon dioxide to release the ammonia.

Any suitable insect trap or system may be employed, such as for example, those traps and systems disclosed in U.S. Pat. Nos. 5,205,064, 6,055,766, and 6,145,243, incorporated herein by reference thereto. Such systems or traps normally employ about 200 to about 500 ml/min of carbon dioxide when in operation. In accordance with this invention it has been discovered that significantly reduced amounts of carbon dioxide may be employed, as low as about 5 to about 40 ml/min, without reducing the attractiveness toward insects, and in many cases increasing the attractiveness toward biting insects, particularly mosquitoes. For example, addition of from about 40 to about 90 ml/min of 20 ppm NO₂ in nitrogen gas significantly increases the attractiveness toward mosquitoes. As a further example, addition of from about 60 to about 80 ml/min of 20 ppm NO₂ in nitrogen while reducing carbon dioxide output to about 20 to about 35 ml/min permit one to attract as many or more mosquitoes as when 250 ml/min or more of carbon dioxide is employed without the NO₂ component.

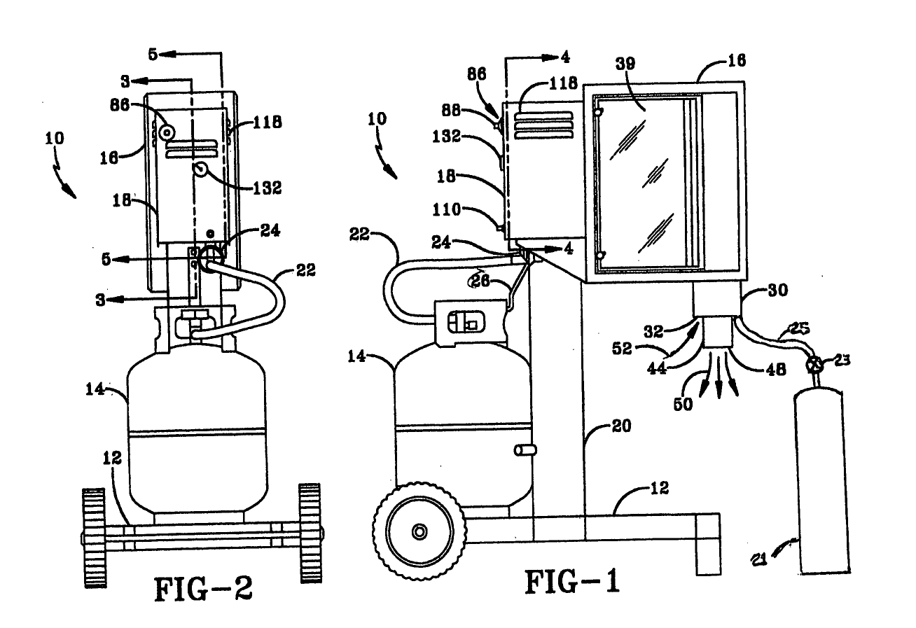

Although, as stated above, this invention may be employed with any suitable trap or system, the invention has been tested and employed in a trap or system as described hereinafter. Referring first to FIGS. 1 and 2, a portable insect trapping apparatus 10 is constructed on a wheeled platform 12 that allows the apparatus to be easily transported to a selected position out of doors. As will be described in greater detail below, trapping apparatus 10 generates a supply of CO₂ gas and water vapor, which is released as an insect attractant, and is also configured to generate all the electrical power it needs to operate. Trapping apparatus 10 can operate continuously and virtually unattended for an entire month on a single, standard 20-pound tank 14 of liquid propane fuel, which is supported on platform 12.

Trapping apparatus 10 includes a trap enclosure 16 and a generator enclosure 18, both of which are supported by an upright, hollow post 20. Post 20 is, in turn, fixed to platform 12. A flexible fuel line 22 connects between tank 14 and a 15 psi regulator 24 mounted on post 20. Tank 14 is secured on platform 12 by a retaining hook 26 that is bolted or otherwise secured to post 20.

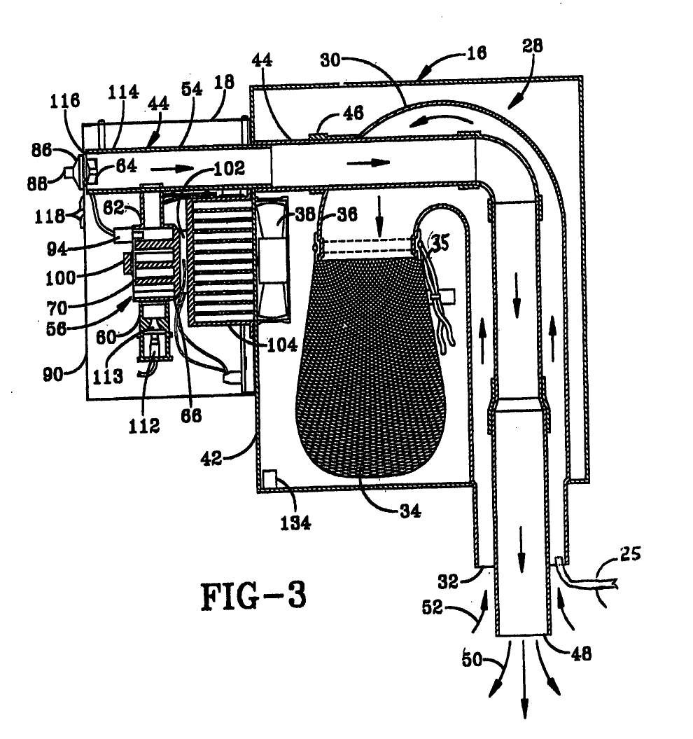

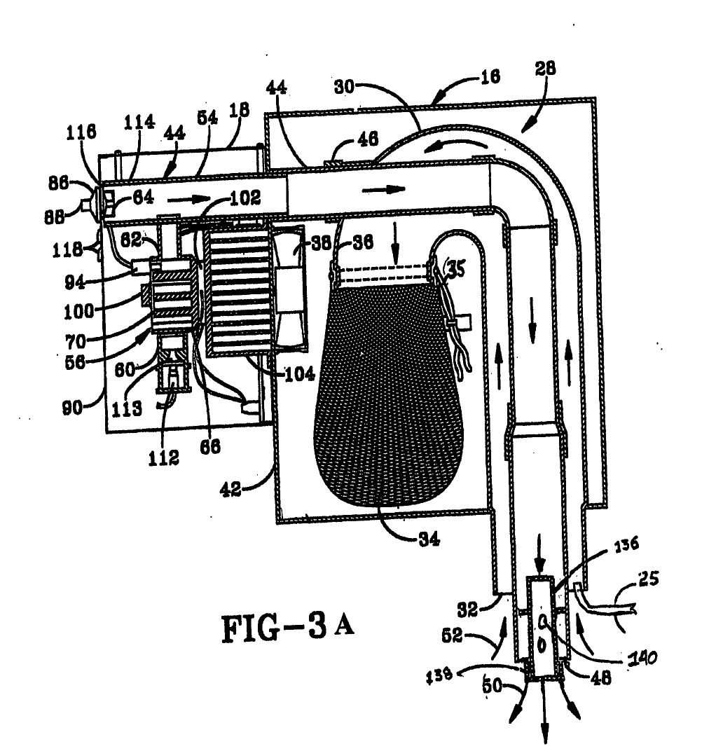

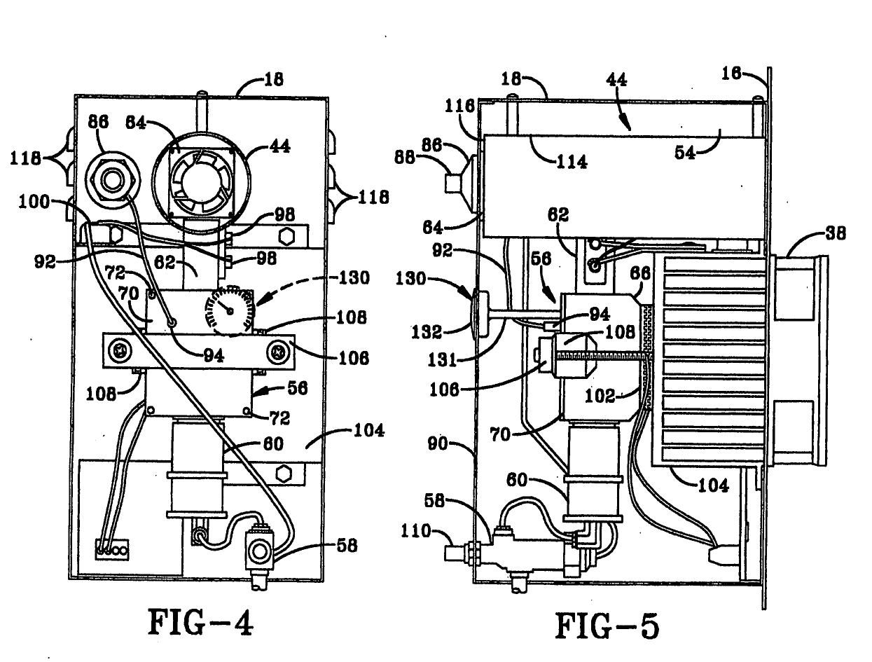

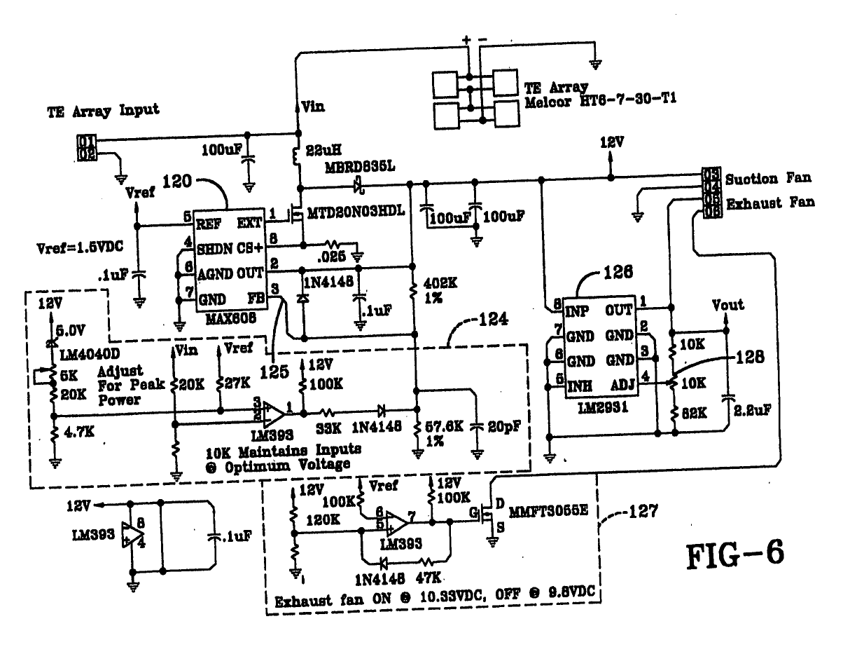

Referring now also to FIG. 3 as well as FIGS. 1 and 2, trapping apparatus 10 includes a counterflow-type insect trap 28. Trap 28 includes a suction tube 30 having an open end 32 extending out from trap enclosure 16. A disposable net bag 34 for trapping insects is tied to the other, outlet end 36 of suction tube 30 inside of trap enclosure 16, with a drawstring 35. A 4.5 inch suction fan 38 is positioned at an opening 40 of an interior wall 42 of trap enclosure 28 to draw air and insects in through suction tube 30, through net bag 34, and exhaust air from trap enclosure 16 into generator enclosure 18. The additional attractant gases of this invention, such as for example, NO₂ in nitrogen, ammonia in nitrogen, acetone in nitrogen, may be provided in a pressurized gas cylinder 21 and introduced through regulator valve 23 and conduit 25 into suction tube 30. One or more such cylinders 21 may be provided to provide one or more of NO₂, ammonia or acetone gases to the trap.

There is a clear, plastic, hinged door 39 on a side of trap enclosure 16 over the area of net bag 34 to observe the catch. To change net bag 34, door 39 is opened, drawstring 35 is relaxed sufficiently to remove net bag 34, and then cinched up to close net bag 34 completely. In cases where trapping apparatus 10 is used for research, net bags 34 can be reusable.

An exhaust tube 44 provides a flow of an insect attractant, such as CO₂ gas, in a direction counter to the direction of flow of air and/or other attractant gases being drawn in through suction tube 30. The exhaust flow is directed downward to the ground, while the air and/or other attractant gases being drawn into trap 28 through suction tube 30 is directed upwards. Exhaust tube 44 enters enclosure 16 through wall 42, then enters suction tube 30 through a side opening 46. Exhaust tube 44 then extends about concentrically within and through suction tube 30. An open end 48 of exhaust tube 44 extends down past open end 32 of suction tube 30 by about three inches. Thus, an exhaust flow is surrounded by an inflow, as indicated by arrows 50, 52, respectively.

Most of exhaust tube 44 is made of sections of interfitting PVC pipe. An exhaust tube extension 54 that extends within generator enclosure 18 is made of a metal. In the described embodiment, extension is made of 2.375 inch id steel tube. Suction tube 30 is primarily a vacuum form with a PVC section at open end 32. Suction tube 30 has an inner diameter of about 4 inches. Exhaust tube, at its open end 48, has an inner diameter of about 2 inches.

An insect attractant that includes CO₂ gas and water vapor is generated by burning propane, or any other suitable hydrocarbon fuel, in a catalytic burner 56 located in generator enclosure 18. If the additional attractant gas is to be NO₂, that NO₂ gas could be provided from this same burning by regulating the burning of the propane in an appropriate amount of air and under appropriate conditions so as to produce both CO₂ and NO₂ in the burning process. Alternatively, an in the preferred method, the burning process may be conducted under such conditions so as to produce essentially only CO₂ as the attractant gas with the desires NO₂ being provided from pressurized gas cylinder 21. As described above, the propane source is propane tank 14, which is the same type of tank as is used with gas outdoor grills. An outlet of regulator 24 (see FIGS. 1 and 2) is coupled to an inlet of a propane safety valve 58. An outlet of safety valve 58 is coupled to a fuel inlet of a carburetor 60. Carburetor 60, which can be an inspirated design Venturi, mixes the propane with air and delivers the mixture to the interior of burner 56. Combustion gases, including heated CO₂ gas and water vapor, are brought to exhaust tube 44 through a chimney 62 portion of burner 56. A two inch exhaust fan 64 is positioned at an open inlet end of exhaust tube 44 to mix air with the combustion gases and urge the mixture to pass through exhaust tube 44.

A high voltage piezo-electric spark igniter 86, of a type often included with gas grills and gas fireplaces, has a manual push-button 88 mounted through a front panel 90 of burner enclosure 18. A high voltage insulated conductor 92 connects the piezo generator to a ceramic-insulated electrode 94 mounted through the combustion chamber cover plate 70. Pressing push-button 88 provides a single spark intended to ignite the propane-air fuel mixture within combustion chamber 68.

A thermoelectric generator includes an array of four bismuth-telluride thermoelectric modules 102 that are connected in series parallel. Module array 102 is mounted between back side 76 of burner 66 and an extruded aluminum heat sink 104. The output voltage of thermoelectric module array 102 is used to operate suction fan 38 and exhaust fan 64, as will be described in greater detail below. Thermoelectric devices produce power by virtue of the Seebeck effect. The voltage and current generated are a direct function of the number of junctions, the difference in temperature from a hot side of modules 102 adjacent to burner 56 to a cold side adjacent to heat sink 104, and the heat flux through modules 102. To increase the temperature gradient between the hot side and the cold side of modules 102, burner 56 is surrounded by insulating material (not shown), and suction fan 38 blows a flow of air onto heat sink 104 to cool it. Fingers 74 conduct heat from the interior of combustion chamber 66 to back side 76 of burner 66, which is pressed against the hot side of modules 102. Thermoelectric module array 102 is clamped between burner 56 and heat sink 104 to maintain good thermal contact to burner 56 and heat sink 104. A tight clamp is obtained by placing a metal bar 106 over a pair of ears 108 that project from the sides of casting 66 and above cover plate 70, and by securely bolting bar 106 to heat sink 104, employing belleville spring washers to maintain a tight clamp during thermal cycling of the system.

Chimney 62 includes two apertures 96 in which a pair of copper-constantan thermocouples 98 are positioned. A cold side of thermocouples 98 is thermally coupled to heat sink 104. Thermocouples 98 are wired in series to a temperature sensitive, bi-metal switch 100 and to safety valve 58. Switch 100 closes safety valve 58 if the temperature of heat sink 104 exceeds about 180° F.

In operation, gas flows from tank 14 through the tank's shut-off valve and flexible line 22 to regulator 24, which drops the gas pressure to 15 psi. The gas continues at 15 psi to the input side of safety valve 58, which is a flame sensing type of valve. An operator manually energizes valve 58 by pressing a button 110 at the front panel 90 of burner enclosure 18. Gas flows from the output side of valve 58 to a sintered metal disc filter 112 located at an entrance to carburetor 60. Filter 112 is designed to prevent gas contaminants from clogging an orifice restrictor in carburetor 60. Immediately after passing through filter 112, the gas escapes to atmospheric pressure through restrictor 113, which has a 0.004 inch diameter orifice. The gas flows through restrictor 113 as a rate of about one pound of propane in 36 hours. Atmospheric air is inspirated into carburetor 60 by a pressure difference created with two diameters of flow (Venturi principle). An adjustment screw (not shown) is employed to adjust airflow in carburetor 60 by restricting the area of the air entrance.

The air-fuel mixture enters combustion chamber 68 and flows through screen 78 into catalytic bead bed 84. Screen 78 acts to inhibit reverse propagation of a flame into carburetor 60. At the top of bead bed 84, the mixture passes through the second screen 80 and then through slots 83 in baffle plate 82. The areas and shapes of slots 83 are designed to inhibit a flame developed above baffle plate 82 from traversing back through slots 83 into bead bed 84. The slot areas are determined by the mixture flow velocity and the flame spreading velocity of the propane-air mixture. By keeping the flow through slots 83 at a higher velocity than the reverse flame propagation velocity, the flame will not spread back into bead bed 84 and blow out.

A flame is initiated above bead bed 84 with spark igniter 86. As the flame burns, heat generated from the combustion warms combustion chamber 68 and bead bed 84. After the flame has been going for some 30 seconds to 45 seconds, the heat is reflected down into catalyst bead bed 84. The catalyst is warmed up and as the catalyst is warmed up it achieves a surface combustion temperature and the flame converts to a catalytic surface combustion in bead bed 84. As a greater amount of the fuel-air mixture oxidizes in bead bed 84, the flame becomes starved of fuel and is extinguished. The combustion continues entirely on a catalytic basis.

Exhaust from the combustion exits vertically through chimney 62 and into extension 54 of exhaust tube 44. Once combustion is achieved, thermocouples 98 generate a current corresponding to the temperature in chimney 62. After about ten second of combustion, thermocouples 98 are warmed enough to provide a current sufficient to energize a coil that holds safety valve 58 in an open position, and push button 110 can be released. Two thermocouples are used in the described embodiment because the temperature of the exhaust gases is far lower than the temperature of a flame sensing application where these valves are generally used. If combustion ceases for any reason, thermocouples 98 cool and allow safely valve 58 to close. Safety valve 58 can only be reopened manually. In the same circuit, temperature sensitive bi-metal switch 100 is installed on heat exchanger 104. If, for any reason, suction fan 38 were not to start and the temperature of heat sink 104 rose above about 180° F., switch 100 would open, shutting off current flow from thermocouples 98 to safety valve 58, and valve 58 would close.

Initially, combustion gases escape into burner enclosure 18 through an opening 114 in extension 54 located directly above chimney 62 or through an open end 116 of extension 54. The combustion gases then pass outside through formed louvers 118. When the thermoelectric generator has developed enough power to operate the small exhaust fan 64, fan 64 mixes the warm exhaust gases with atmospheric air and blows the mixture out through opening 48 of exhaust tube 44. Louvers thus serve two purposes—they allow exhaust gases to flow out before exhaust fan 64 begins operation, and they allow atmospheric air to flow into enclosure 18, mixing with exhaust gases for cooling and reducing CO₂ gas concentration when fan 64 operates.

The output voltage of thermoelectric module array 102 is not sufficient to operate suction fan 38 and exhaust fan 64 directly. Referring now also to FIG. 6, the output of thermoelectric module array 102 is fed to the input of a step-up controller 120 located on a circuit board 122. When the voltage reaches about 2 Vdc, controller 120 turns on and provides an output of about 4 Vdc. This voltage is insufficient to start the fans but provides power to a comparator circuit 124. Comparator circuit 124 measures the power capability of thermoelectric module array 102, and, through a feedback path 125 to controller 120, modulates the output voltage of thermoelectric module array 102 to maintain peak power. Without feedback, module array 102 would be allowed to produce current until internal impedance regulated the output voltage. In this mode, the performance point would always settle on the wrong side of the inverse parabolic operating curve. The described circuit allows thermoelectric module array 102 to track and maintain peak power from shortly after start-up to operating temperature.

Suction fan 38 begins to operate when the output voltage reaches 7 Vdc. This is achieved when the temperature of catalyst bead bed 84 reaches about 150° F. The temperature of bead bed will continue to rise up to a running temperature of about 320° F. Suction fan 38 generates an inflow of air into trap 28 through suction tube 30, while at the same time cooling the cold side heat exchanger 104 to increase the temperature difference across thermoelectric module array 102 to produce more power. The output voltage continues to increase with greater temperature differences across thermoelectric module array 102 until reaching the set output of controller 120 at 11 Vdc, and the temperatures are stabilized at their maxima. As the voltage passes about 10 Vdc, a second comparator circuit 127 with fixed hysteresis allows exhaust fan 64 to switch on. The voltage to exhaust fan 64, and thus the exhaust flow velocity and the CO₂ concentration in the exhaust flow, is set by a regulator 126. In the described embodiment, step-up controller 120 is a Maxim 608 controller, and voltage regulator 126 is an LM2931 regulator.

A potentiometer 128 is provided to adjust the speed of exhaust fan 64 while measuring the CO₂ concentration in exhaust tube 44. Thus, the speed of exhaust fan 64 can be adjusted up or down to provide a CO₂ concentration in exhaust tube 44 to attract mosquitoes that prey on smaller and larger animals, respectively.

By mixing ambient air with the hot combustion gases from burner 56, exhaust fan 64 not only reduces the CO₂ concentration, but also reduces the temperature of the exhaust flow to less than about 30-45° F. above ambient temperature. It is important that the temperature of the exhaust flow exceed ambient temperature because mosquitoes are attracted to heat, but it is equally important that the exhaust temperature not exceed about 115° F. when flowing out from exhaust tube 44. Mosquitoes do not home in on a source that exceeds that temperature.

Trap 28 is configured to provide an inflow of air into suction tube 30 with an air speed of about 550 ft/min. This speed inhibits most mosquitoes from being able to fly against the inflow and out of trap 28.

Trapping apparatus 10 also includes a bi-metal temperature sensor 130 with its stem 131 inserted through cover plate 70 of burner 56 and with its indicator face 132 being exposed through front panel 90 of burner enclosure 18. Sensor 130 immediately begins showing a temperature rise after burner 56 is ignited. A point on indicator face 132 is marked to prompt the operator to release gas valve button 110 when the temperature rises above that point. Indicator face 132 has operating ranges (ready; ignition achieved; start-up; and normal) rather than degrees temperatures marked to reduce operator confusion.

Insect disabling devices other than net bag 34 can be employed with trap 28. For example, poison can be placed within enclosure 16, or an electronic “bug zapper” can be positioned to receive insects drawn in through suction tube 30.

Volatile insect attractant compounds, such as, for example, octenol, or a solid or liquid form of one of the co-attractants of this invention, can be used with trap 28. A small open vial 134 (FIG. 3) containing a volatile insect attractant compound can be placed in either of enclosures 16 or 18. The evaporating compound will be drawn into the exhaust flow by exhaust fan 64. One or more of those vials may be employed to provide for example, one or more of octenol, ammonia from ammonia salts, or NO₂ from nitric acid and nitrate salts. Alternatively, as shown in FIG. 3A, the volatile attractant compounds, such as, for example, octenol, or a solid or liquid form of one of the co-attractants of this invention, can be used with trap 28, by providing a container 136 in exhaust tube 44 for holding the volatile insect attractant. The attractant material is placed in container 136 and the container is capped with end cap 138. Vent holes 140 in the container permit emission of the volatile attractant material into exhaust tube 44, and the volatile attractant, along with the CO₂ in tube 44 exhausts as indicated by arrows 50.

The invention is illustrated by, but not limited to, the following examples demonstrating the effectiveness of the invention.

### EXAMPLE 1

These tests were conducted in the Danbury, Conn. area employing American Biophysics Corporation Mosquito Magnet® (Liberty model) traps of the general type trap previously described hereinbefore that release carbon dioxide in an amount within the range of from about 250 to 500 ml/min. Two traps were employed in adjacent areas about 75 feet apart. To establish a baseline control the traps were operated in the two areas over five days. The trap in area 1 (Trap 1) caught 37% of the mosquitoes caught, and the trap in area 2 (Trap 2) caught 63% of the mosquitoes caught. These control evaluations establish that area 2 is the more active mosquito area and provides baseline (relative) catch percentages for the two areas. Tests were then run where Trap 1 was modified to include a flow of certain specified ml/min of 20 ppm NO₂ in nitrogen gas, from a pressurized gas cylinder 21 in the manner described before, in addition to the established flow of carbon dioxide, and while Trap 2 had no NO₂ being introduced from a pressurized gas cylinder, that is, the trap was with gas cylinder 21, vale 23 and conduit 25 in the previous description of the trap. The results of the runs are set forth in Table 1.

TABLE 1

| | Ml/min 20 ppm | Percent | Percent |
|---|---|---|---|
| | NO₂ in nitrogen | mosquitoes | mosquitoes |
| Test No. | in Trap 1 | caught in Trap 1 | caught in Trap 2 |
| 1 | 60 | 60 | 40 |
| 2 | 85 | 75 | 25 |
| 3 | 200 | 57 | 43 |
| Control | 0 | 37 | 63 |

Even though, from the controls, it was established that area 2 was the more active mosquito area, Trap 1 with the NO₂ in these three runs caught significantly more mosquitoes than the control trap in area 2 without the NO₂ component.

### EXAMPLE 2

These tests were conducted in the Danbury, Conn. area employing American Biophysics Corporation Mosquito Magnet® (Liberty model) traps of the general type trap previously described that release carbon dioxide in an amount within the range of from about 250 to 500 ml/min. The traps also released octenol as an attractant. Two traps were employed in adjacent areas about 75 feet apart. To establish a baseline control the traps were operated in the two areas over nine test periods. The trap in area 1 (Trap 1) caught 47% of the mosquitoes caught, and the trap in area 2 (Trap 2) caught 53% of the mosquitoes caught. These control evaluations establish that area 2 is the more active mosquito area and provides baseline (relative) catch percentages for the two areas. Tests were then run where Trap 2 was modified by addition of certain specified ml/min of 20 ppm NO₂ in nitrogen gas while Trap 1 remained unmodified. The results of the runs are set forth in Table 2

TABLE 2

| | Ml/min of 20 ppm | Percent | Percent |
|---|---|---|---|
| | NO₂ in nitrogen | mosquitoes | mosquitoes |
| Run No. | in Trap 2 | caught in Trap 1 | caught in Trap 2 |
| 1 | 40 | 20 | 80 |
| 2 | 80 | 30 | 70 |
| 3 | 53 | 24 | 76 |
| 4 | 15 | 33 | 67 |
| Control | 0 | 47 | 53 |

Even though, from the controls, it was established that area 1 was the more active mosquito area, Trap 2 with the NO₂ in these four runs caught significantly more mosquitoes than the control trap in area 1 without the NO₂ component.

### EXAMPLE 3

These tests were run with a modified American Biophysics Corporation Mosquito Magnet® (Liberty model) traps of the general type trap previously described. Propane was not used and no heat generated and the fans were modified to be powered by an outside electrical power source. The control trap was a standard American Biophysics Corporation Mosquito Magnet® (Liberty model) trap. Octenol was present in each trap as an additional attractant. Again these tests were run in the Danbury, Conn. area in two adjacent test areas about 75 feet apart. Identical traps were run in areas 1 and 2 as controls to establish an attractiveness baseline. Trap 1 in area 1 caught 65% of the mosquitoes caught and Trap 2 in area 2 caught 35% of the mosquitoes caught. Trap 2 was maintained unmodified as a control in the test runs, and Trap 1 was modified as described above so that the carbon dioxide output could be controlled by using a pressured cylinder and to add specified ml/min amounts of 20 ppm NO₂ in nitrogen gas from the pressurized gas cylinder, as set forth in Table 3. Lactic acid (1 gram) was also present in Trap 1 in vials in the test runs.

TABLE 3

| | ml/min 20 ppm | | |
|---|---|---|---|
| | NO₂ in nitrogen | Percent | Percent |
| | and ml/min CO₂ | mosquitoes | mosquitoes |
| Run No. | in Trap 1 | caught in Trap 1 | caught in Trap 2 |
| 1 | 80 ml/min NO₂ | 78 | 22 |
| | 35 ml/min CO₂ | | |
| 2 | 60 ml/min NO₂ | 83 | 17 |
| | 25 ml/min CO₂ | | |
| Control, 2 | 0 ml min NO₂ | 65 | 35 |
| standard | ca. 300 ml/min CO₂ | | |
| Mosquito | | | |
| Magnets | | | |

The results indicate that the presence of NO₂ increases the attraction of mosquitoes to Trap 1. Additionally, the presence of NO₂ enables the amount of carbon dioxide released to be substantially reduced (from 200-500 ml/min to either 21 or 35 ml/min) and yet still maintain or improve the attractiveness of the trap to mosquitoes. This enables one to employ traps requiring significantly less carbon dioxide. These result are even more surprising when no mosquitoes were caught in similar traps when 45 ml/min and 80 ml/min 20 ppm NO₂ in nitrogen was introduced into the traps from a pressurized gas cylinder and the trap generated no CO₂, i.e., in the absence of CO₂, NO₂ attracted no mosquitoes.

### EXAMPLE 4

These tests were conducted in the Danbury, Conn. area employing American Biophysics Corporation Mosquito Magnet® (Liberty model) traps of the general type previously described that release carbon dioxide in an amount within the range of from about 250 to 500 ml/min. The traps also released octenol from a container in the exhaust tube as an attractant in the manner shown by FIG. 3A. Two traps were employed in adjacent areas. To establish a baseline control the traps were operated in the two areas over nine test periods. The trap in area 1 (Trap 1) caught 47% of the mosquitoes caught, and the trap in area 2 (Trap 2) caught 53% of the mosquitoes caught. These control evaluations establish that area 2 is the more active mosquito area and provides baseline (relative) catch percentages for the two areas. Tests were then run where Trap 2 was modified by addition of certain specified ml/min of 1000 ppm ammonia in nitrogen gas from pressurized gas containers and certain specified ml/min of 20 ppm NO₂ in nitrogen gas from another pressurized gas container while Trap 1 had no ammonia or NO₂ gases introduced from pressurized gas containers. Results of the runs are set forth in Table 4.

TABLE 4

| | Ml/min 100 ppm | | | |
|---|---|---|---|---|
| | NH₃ in nitrogen | | | |
| | and ml/min 20 ppm | | Percent | Percent |
| | NO₂ in nitrogen | | mosquitoes | mosquitoes |
| Run No. | added to Trap 2 | | caught in Trap 1 | caught in Trap 2 |
| 1 | 80 | ml/min NH₃ | 38 | 62 |
| | 80 | ml/min NO₂ | | |
| 2 | 70 | ml/min NH₃ | 25 | 75 |
| | 35 | ml/min NO₂ | | |
| 3 | 40 | ml/min NH₃ | 19 | 81 |
| | 90 | ml/min NO₂ | | |
| 4 | 20 | ml/min NH₃ | 44 | 66 |
| | 20 | ml/min NO₂ | | |
| 5 | 50 | ml/min NH₃ | 12 | 88 |
| | 18 | ml/min NO₂ | | |
| 6 | 15 | ml/min NH₃ | 20 | 80 |
| | 45 | ml/min NO₂ | | |
| 7 | 145 | ml/min NH₃ | 37 | 63 |
| | 200 | ml/min NO₂ | | |
| 8 | 35 | ml/min NH₃ | 26 | 74 |
| | 35 | ml/min NO₂ | | |
| 9 | 35 | ml/min NH₃ | 39 | 61 |
| | 40 | ml/min NO₂ | | |
| Control | 0 | ml/min NH₃ | 47 | 53 |
| | 0 | ml/min NO₂ | | |

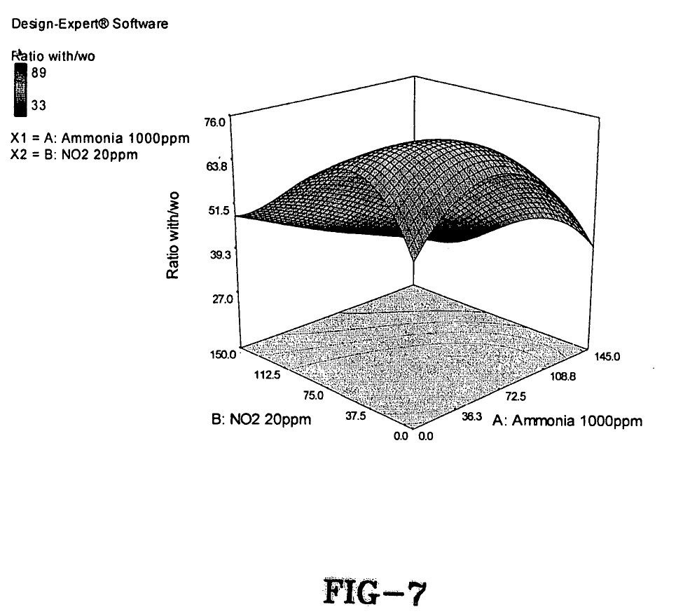

Addition of both ammonia and NO₂ significantly increased the attraction of mosquitoes to Trap 2. When the results of the runs in Examples 2 and 4 along with other similar test results totaling 39 experiments are programmed into the software program Design-Expert, version 6, from Stat-Ease, Inc. of Minneapolis, Minn., the program produces the graph in FIG. 7 that indicates that the optimum amount of 20 ppm NO₂ to be employed with the 250-500 ml/min carbon-dioxide when no ammonia is employed is approximately 49 ml/min of 20 ppm NO₂ in nitrogen gas, that the optimum amount of 1000 ppm ammonia to be employed with the 250-500 ml/min carbon dioxide when no NO₂ is employed is approximately 59 ml/min, and that the optimum amount of both ammonia and NO₂ to be employed with the 250-500 ml/min carbon dioxide is 42 ml/min 1000 ppm ammonia in nitrogen gas and 33 ml/min 20 ppm NO₂ in nitrogen gas.

### EXAMPLE 5

These tests were run employing American Biophysics Corporation Mosquito Magnet® (Liberty model) traps of the general type previously described emitting octenol and 300+ ml/min carbon dioxide. The tests were run in two adjacent areas in Danbury, Conn. 40 ml of carbon dioxide containing 25 ppm NO₂ plus 500 ppm acetone was alternated between the two traps each day over a period of 18 days. Over the eighteen-day period, the traps containing the NO₂ and the acetone in the 40 ml/min CO₂ stream caught 26% more mosquitoes than the traps without the added NO₂ and acetone.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A trap or system employing carbon dioxide as an attractant for attracting and trapping biting insects, wherein in addition to the carbon dioxide the trap or system also includes an attractant effective amount of a component selected from the group consisting of:
(a) NO₂ or a material producing NO₂,
(b) NO₂ or a material producing NO₂, and NH₃ or ammonium salts of acids,
(c) NO₂ or a material producing NO₂, and acetone, and
(d) NO₂ or a material producing NO₂, NH₃ or ammonium salts of acids, and acetone.

2. A trap or system according to claim 1, wherein the component comprises NO₂ gas.

3. A trap or system according to claim 1, wherein the NO₂ gas and ammonium salts of acids.

4. A trap or system according to claim 1, wherein the component comprises NH₃ or ammonium salts of acids and NO₂ or NO₂ producing salt.

5. A trap or system according to claim 1, wherein the component comprises NO₂ gas and acetone.

6. A trap or system according to claim 1, wherein the component comprises acetone and NO₂ or NO₂ producing salt.

7. A trap or system according to claim 1, wherein the component comprises NH₃ or ammonium salts of acids, acetone and NO₂ or NO₂ producing salt.

8. A trap or system according to claim 1 additionally comprising one or more other attractants selected from the group consisting of octenol and lactic acid.

9. A method for attracting biting insects comprising emitting from a trap or system an attractant effective amount of carbon-dioxide and a further attractant component selected from the group consisting of
(a) NO₂ or a material producing NO₂,
(b) NO₂ or a material producing NO₂, and NH₃ or ammonium salts of acids,
(c) NO₂ or a material producing NO₂, and acetone, and
(d) NO₂ or a material producing NO₂, NH₃ or ammonium salts of acids, and acetone.

10. The method according to claim 9, wherein the method is a method of attracting mosquitoes.

11. A method according to claim 10, wherein the component comprises NO₂ gas.

12. A method according to claim 10, wherein the component comprises NO₂ and ammonium salts of acids.

13. A method according to claim 10, wherein the component comprises NH₃ or ammonium salts of acids and NO₂ or NO₂ producing salt.

14. A method according to claim 10, wherein the component comprises acetone and NO₂ gas.

15. A method according to claim 10, wherein the component comprises acetone and NO₂ or NO₂ producing salt.

16. A method according to claim 10, wherein the component comprises NH₃ or ammonium salts of acids, acetone and NO₂ or NO₂ producing salt.

17. A method according to claim 10 additionally comprising one or more other attractants selected from the group consisting of octenol and lactic acid.
